(19) United States
(12) Patent Application Publication
(10) Pub. No.: US 2026/0220597 A1
(43) Pub. Date: Jul. 30, 2026

(54) INVENTORY PLAN GENERATION SYSTEM, INVENTORY PLAN GENERATION METHOD, AND RECORDING MEDIUM

(71) Applicant: NEC Corporation, Tokyo (JP)

(72) Inventors: Yudai Yamaguchi, Tokyo (JP); Riki Eto, Tokyo (JP)

(73) Assignee: NEC Corporation, Tokyo (JP)

(21) Appl. No.: 19/434,209

(22) Filed: Dec. 29, 2025

(30) Foreign Application Priority Data
Jan. 29, 2025 (JP) 2025-013291

(51) Int. Cl. G06Q 10/087; G06Q 10/0631

(52) U.S. Cl. CPC G06Q 10/08726; G06Q 10/06315

(57) ABSTRACT

An inventory plan generation system includes at least one memory storing instructions, and at least one processor configured to execute the instructions to: acquire stock information, demand prediction information, money amount information, and constraint information related to a product, generate inventory plan information related to the product in such a way as to suppress a predicted stockout and an excessive stock based on the stock information, the demand prediction information, the money amount information, and the constraint information, based on a suppression balance of a stockout and an excessive stock of the product, the suppression balance being calculated based on an instance of inventory plan information related to the product, and present the suppression balance and the inventory plan information to a user.

This application is based upon and claims the benefit of priority from Japanese patent application No. 2025-013291, filed on Jan. 29, 2025, the disclosure of which is incorporated herein in its entirety by reference.

### TECHNICAL FIELD

The present disclosure relates to an inventory plan generation system, an inventory plan generation method, and an inventory plan generation program.

### BACKGROUND ART

JP 2005-15140 A describes a technique of calculating an order quantity of a product based on a result of subtracting a scheduled stock from a sum of a safe stock quantity and a total demand quantity calculated based on past results.

### SUMMARY

An inventory plan generation system according to an exemplary aspect of the present disclosure includes at least one memory storing instructions; and at least one processor configured to execute the instructions to: acquire stock information, demand prediction information, money amount information, and constraint information related to a product, predict a stockout and an excessive stock of the product by using the stock information, the demand prediction information, the money amount information, and the constraint information, acquire a suppression balance between stockout and excessive stock of the product, the suppression balance being calculated based on an instance of inventory plan information related to the product, generate inventory plan information related to the product in such a way as to suppress the stockout and the excessive stock predicted, based on the suppression balance, and present the suppression balance and the inventory plan information to a user.

An inventory plan generation method according to an exemplary aspect of the present disclosure includes acquiring stock information, demand prediction information, money amount information, and constraint information related to a product, predicting a stockout and an excessive stock by using the stock information, the demand prediction information, the money amount information, and the constraint information, acquiring a suppression balance between stockout and excessive stock of the product, the suppression balance being calculated based on an instance of inventory plan information related to the product, generating inventory plan information related to the product in such a way as to suppress the stockout and the excessive stock predicted, based on the suppression balance, and presenting the suppression balance and the inventory plan information to a user.

A non-transitory computer-readable recording medium according to an exemplary aspect of the present disclosure stores an inventory plan generation program causing a computer to execute processing including, acquiring stock information, demand prediction information, money amount information, and constraint information related to a product, predicting a stockout and an excessive stock by using the stock information, the demand prediction information, the money amount information, and the constraint information, acquiring a suppression balance between stockout and excessive stock of the product, the suppression balance being calculated based on an instance of inventory plan information related to the product, generating inventory plan information related to the product in such a way as to suppress the stockout and the excessive stock predicted, based on the suppression balance, and presenting the suppression balance and the inventory plan information to a user.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an inventory plan generation system according to the present disclosure;

FIG. 2 is a flowchart illustrating a flow of an inventory plan generation method according to the present disclosure;

FIG. 3 is a block diagram illustrating a configuration of the inventory plan generation system according to the present disclosure;

FIG. 4 is a block diagram illustrating a configuration of an inventory plan generation device according to the present disclosure;

FIG. 5 is a diagram schematically illustrating processing of generating inventory plan information using a suppression balance according to the present disclosure;

FIG. 6 is a flowchart illustrating a flow of the inventory plan generation method according to the present disclosure;

FIG. 7 is a diagram illustrating an example of a screen displayed in the inventory plan generation method according to the present disclosure;

FIG. 8 is a diagram illustrating an example of a screen including a plurality of pieces of inventory plan information according to the present disclosure;

FIG. 9 is a flowchart illustrating a flow of a calculation method according to the present disclosure;

FIG. 10 is a diagram illustrating an example of a screen displayed in the calculation method according to the present disclosure; and

FIG. 11 is a block diagram illustrating a hardware configuration of a computer that functions as each of the devices according to the present disclosure.

### EXAMPLE EMBODIMENT

Hereinafter, example embodiments of the present disclosure will be exemplified. However, the present disclosure is not limited to the following example embodiments, and various modifications can be made within a scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Effects mentioned in the following example embodiments are examples of effects expected in the exemplary example embodiments, and do not define extension of the present disclosure. That is, example embodiments that do not provide the effects mentioned in each of the example embodiments described below can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment can also be adopted in another exemplary example embodiment included in the present disclosure within a range in which no particular technical problem occurs.

### (Configuration of Inventory Plan Generation System 1)

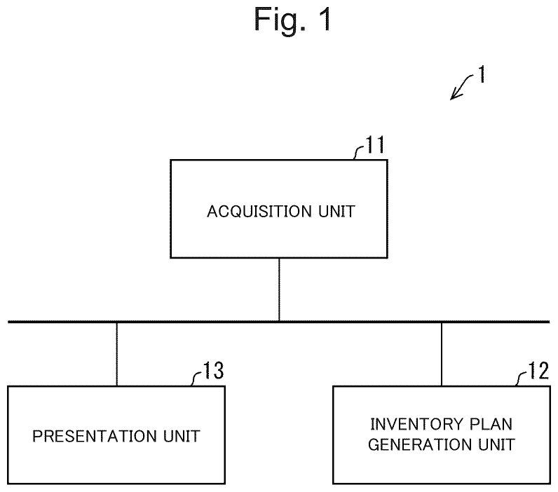

A configuration of an inventory plan generation system 1 will be described with reference to FIG. 1. FIG. 1 is a block diagram illustrating a configuration of the inventory plan generation system 1. As illustrated in FIG. 1, the inventory plan generation system 1 includes an acquisition unit 11, an inventory plan generation unit 12, and a presentation unit 13. The acquisition unit 11 is an example of a configuration for implementing an acquisition means. The inventory plan generation unit 12 is an example of a configuration for implementing an inventory plan generation means. The presentation unit 13 is an example of a configuration for implementing a presentation means. The inventory plan generation system 1 may be configured by one computer or may be configured by a plurality of computers.

The acquisition unit 11 acquires stock information, demand prediction information, money amount information, and constraint information related to a product. Here, for example, the stock information indicates information related to the stock of the product, and as an example, may include some or all of the current stock quantity, the scheduled delivery quantity, the number or ratio of the stock (hereinafter described as a near disposal stock) with a close disposal deadline, and the like. Whether it is the near disposal stock may be determined by a predetermined condition. The predetermined condition may be, for example, a condition that the disposal deadline is reached or exceeded at the timing of next line up in the storefront, but is not limited thereto. The stock information is not limited to the example described above. The stock information may be acquired by input of a user or may be acquired from a database storing the stock information.

Furthermore, for example, the demand prediction information indicates information related to the demand prediction of the product, and as an example, may include some or all of the demand prediction quantity, the demand prediction error, and the like. Furthermore, the demand prediction may be performed over a plurality of consecutive timings (e.g., a plurality of consecutive dates etc.). In this case, the demand prediction information may include a time series of information related to the demand prediction. For example, the demand prediction information may include a demand prediction quantity and a demand prediction error associated with each date of the next week. The demand prediction error may be a past demand prediction error or a demand prediction error designated by the user. However, the demand prediction information is not limited to the example described above. The demand prediction information may be acquired by input of a user or may be acquired from a demand prediction device that performs demand prediction.

In addition, for example, the money amount information is information including a money amount related to a product, and may include a cost price and a selling price of the product by way of an example. The cost price is used to calculate a disposal amount due to excessive stock. The selling price is used to calculate an amount of stockout indicating the loss due to stockout. However, the money amount information is not limited to these.

Furthermore, for example, the constraint information is information indicating a constraint in the inventory plan, and examples thereof include a constraint regarding an upper limit stock quantity, a constraint regarding sales result, and the like. However, the constraint information is not limited to these.

The inventory plan generation unit 12 generates inventory plan information related to a product in such a way as to suppress a predicted stockout and an excessive stock based on stock information, demand prediction information, money amount information, and constraint information based on a suppression balance of a stockout and an excessive stock of a product, the suppression balance being calculated based on a case of inventory plan information related to a product. Here, in the inventory plan, the possibility that the excessive stock increases as the stockout is suppressed becomes higher, and the possibility that the stockout increases as the excessive stock is suppressed becomes higher. That is, the stockout and the excessive stock are in a trade-off relationship. The suppression balance is information indicating to what extent each of a stockout and an excessive stock having a trade-off relationship is to be suppressed.

The inventory plan information changes if the suppression balance is different.

For example, the suppression balance can be represented by a weight θ1 indicating an extent of suppressing the excessive stock and a weight θ2 indicating an extent of suppressing the stockout. The weights θ1 and θ2 are parameters such that when one is increased, the other is decreased. For example, the sum of θ1 and θ2 may be constant.

In a case where the sum is constant, the data format of the suppression balance may include one weight (e.g., θ1) and may not include the other weight (e.g., θ2), and in this case, the other weight may be calculated at the time of generating the inventory plan information. Furthermore, for example, the suppression balance may be calculated by machine learning based on a case of the inventory plan information.

Furthermore, the “inventory plan information” may include, for example, a planned stock quantity (hereinafter described as planned stock quantity). For example, the planned order quantity (hereinafter described as planned order quantity) may be calculated based on the planned stock quantity. For example, as a method of calculating the planned order quantity, the holding stock quantity and/or the scheduled delivery quantity may be subtracted from the planned stock quantity, but the method is not limited thereto.

Furthermore, the “inventory plan information” may include, for example, a planned order quantity. For example, when it is difficult to calculate the planned order quantity only based on the planned stock quantity, the planned order quantity may be included in the “inventory plan information”.

In addition, the “inventory plan information” may include a time series of the planned stock quantity and/or the planned order quantity. For example, “inventory plan information” may include planned stock quantity and/or planned order quantity associated with each date of the next week.

The presentation unit 13 presents the suppression balance and the inventory plan information to the user. For example, the presentation unit 13 may display the suppression balance and the inventory plan information on the display device. As a result, the user can know the suppression balance calculated from the case of the inventory plan information and the inventory plan information generated based on the suppression balance. For example, the user may directly adopt the presented inventory plan information as the actual inventory plan. Furthermore, for example, the user may adopt inventory plan information generated again by adjusting the presented suppression balance (in other words, by performing “intention”) as the actual inventory plan. As a result, the user can easily formulate an inventory plan in consideration of a strategy of to what extent each of the stockout and the excessive stock has been suppressed in the case of the inventory plan information.

### (Effect of Inventory Plan Generation System 1)

As described above, the inventory plan generation system 1 adopts a configuration including the acquisition unit 11 for acquiring the stock information, the demand prediction information, the money amount information, and the constraint information related to the product, the inventory plan generation unit 12 for generating the inventory plan information related to the product in such a way as to suppress the predicted stockout and the excessive stock based on the stock information, the demand prediction information, the money amount information, and the constraint information based on the suppression balance of the stockout and the excessive stock of the product, the suppression balance being calculated based on the case of the inventory plan information related to the product, and the presentation unit 13 for presenting the suppression balance and the inventory plan information to the user. Therefore, according to the inventory plan generation system 1, an effect is obtained that it is possible to assist the formulation of the inventory plan in consideration of the strategy of to what extent each of the stockout and the excessive stock is to be suppressed. In addition, an effect is obtained that the suppression balance in the case of the inventory plan information related to the product is visualized.

### (Flow of Inventory Plan Generation Method S1)

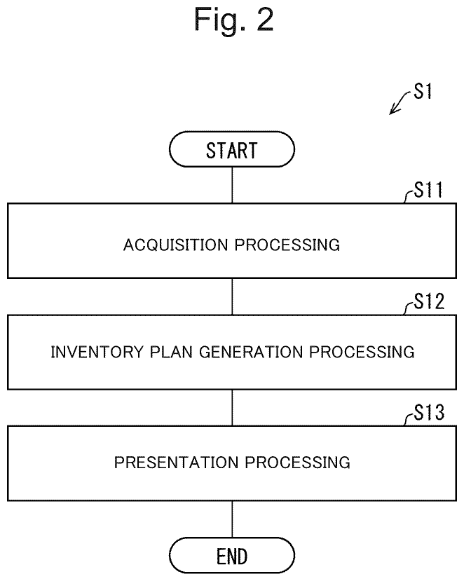

A flow of an inventory plan generation method S1 will be described with reference to FIG. 2. For example, in a case where the above-described inventory plan generation system 1 includes at least one processor, the inventory plan generation system 1 executes an inventory plan generation method S1. FIG. 2 is a flowchart illustrating a flow of the inventory plan generation method S1. As illustrated in FIG. 2, the inventory plan generation method S1 includes acquisition processing S11, inventory plan generation processing S12, and presentation processing S13.

In the acquisition processing S11, at least one processor (e.g., the acquisition unit 11) acquires stock information, demand prediction information, money amount information, and constraint information related to a product. Details of the acquisition processing S11 will be described similarly to the acquisition unit 11, and thus detailed description will not be repeated.

In the inventory plan generation processing S12, at least one processor (e.g., the inventory plan generation unit 12) generates inventory plan information related to a product in such a way as to suppress a predicted stockout and an excessive stock based on stock information, demand prediction information, money amount information, and constraint information based on a suppression balance of a stockout and an excessive stock of a product, the suppression balance being calculated based on a case of inventory plan information related to a product. Details of the inventory plan generation processing S12 will be described similarly to the inventory plan generation unit 12, and thus detailed description will not be repeated.

In presentation processing S13, at least one processor (e.g., the presentation unit 13) presents the suppression balance and the inventory plan information to the user. Details of the presentation processing S13 will be described similarly to the presentation unit 13, and thus detailed description will not be repeated.

### (Effect of Inventory Plan Generation Method S1)

As described above, the inventory plan generation method S1 adopts a configuration including the acquisition processing S11 in which the at least one processor acquires stock information, demand prediction information, money amount information, and constraint information related to a product, the inventory plan generation processing S12 in which the at least one processor generates inventory plan information related to a product in such a way as to suppress a predicted stockout and an excessive stock based on the stock information, demand prediction information, money amount information, and constraint information based on a suppression balance of a stockout and an excessive stock of the product, the suppression balance being calculated based on a case of the inventory plan information related to the product, and the presentation processing S13 in which the at least one processor presents the suppression balance and the inventory plan information to a user. Therefore, according to the inventory plan generation method S1, the same effect as that of the inventory plan generation system 1 can be obtained.

### Second Exemplary Example Embodiment

A second exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other example embodiments included in the present disclosure within the scope in which no particular technical problem occurs.

### (Configuration of Inventory Plan Generation System 1A)

The inventory plan generation system 1A is a system used in a company that sells products (e.g., a retail company, a wholesale company, a manufacturer, and the like.). Hereinafter, an example of use in a company that sells products in a plurality of stores will be mainly described. However, the number of stores is not limited to a plurality, and may be one, or may be zero. In a case where the number of stores is zero, for example, the product may be sold online.

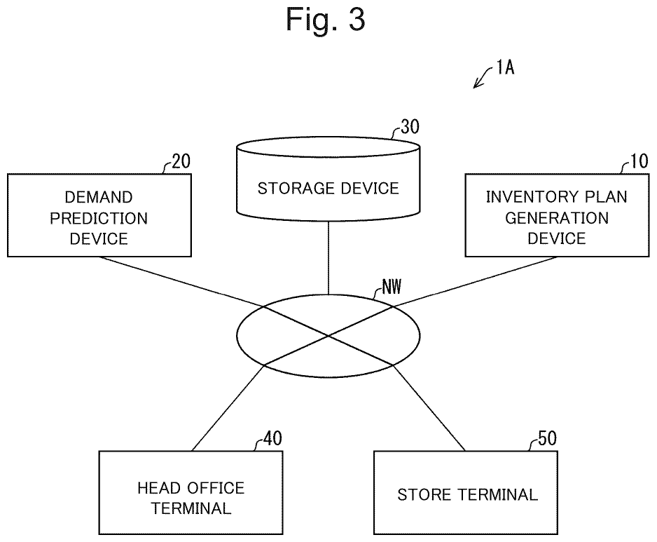

A configuration of the inventory plan generation system 1A will be described with reference to FIG. 3. FIG. 3 is a block diagram illustrating a configuration of the inventory plan generation system 1A. The inventory plan generation system 1A includes an inventory plan generation device 10, a demand prediction device 20, a storage device 30, a head office terminal 40, and a store terminal 50. Each of these devices communicates with other devices via the network NW as necessary. The network NW may include a wired or wireless Local Area Network (LAN), a Wide Area Network (WAN), and/or a mobile data communication network, but is not limited thereto.

FIG. 3 illustrates one inventory plan generation device 10, one demand prediction device 20, one storage device 30, one head office terminal 40, and one store terminal 50, but the number of some or all of them may be two or more. Some or all of these devices may be configured by the same computer. At least one of these devices may be configured by a plurality of computers.

### (Inventory Plan Generation Device 10)

The inventory plan generation device 10 is a device that generates inventory plan information related to a product. In addition, the inventory plan generation device 10 can calculate a suppression balance used to generate inventory plan information related to a product by machine learning. Details of the inventory plan generation device 10 will be described later. The inventory plan information generated by the inventory plan generation device 10 or the calculated suppression balance is presented to the user of the head office terminal 40 or the store terminal 50.

### (Demand Prediction Device 20)

The demand prediction device 20 is a device that performs demand prediction of a product. For example, the demand prediction device 20 performs demand prediction of a designated product to generate demand prediction information, and outputs the demand prediction information to the inventory plan generation device 10. The demand prediction information is as described above, and thus detailed description will not be repeated.

### (Storage Device 30)

The storage device 30 stores information to be referred to by the inventory plan generation device 10. For example, the storage device 30 may store stock information, money amount information, constraint information, and various types of reference information. Details of these pieces of information will be described later. The information stored in the storage device 30 can be updated at an appropriate timing. For example, the stock information may be updated every day, or the product information may be updated every week. The type and update timing of the information stored in the storage device 30 are not limited to the examples described above.

### (Head Office Terminal 40 and Store Terminal 50)

The head office terminal 40 is, for example, a terminal used by a user of a department that supervises inventory plans in a plurality of stores. Furthermore, the store terminal 50 is, for example, a terminal used by a user who formulates an inventory plan in each store. For example, an input device and a display device (both not illustrated) are connected to or incorporated in the head office terminal 40 and the store terminal 50. Hereinafter, in a case where the user of the head office terminal 40 and the user of the store terminal 50 are not particularly distinguished, they are simply described as users.

### (Detailed Configuration of Inventory Plan Generation Device 10)

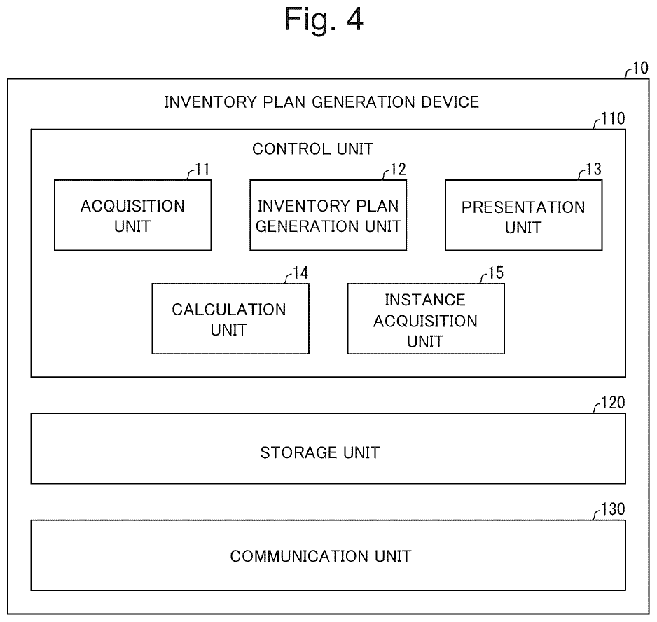

A configuration of the inventory plan generation device 10 will be described with reference to FIG. 4. FIG. 4 is a block diagram illustrating a configuration of the inventory plan generation device 10. As illustrated in FIG. 4, the inventory plan generation device 10 includes a control unit 110, a storage unit 120, and a communication unit 130. The control unit 110 integrally controls each unit of the inventory plan generation device 10. For example, the control unit 110 includes a calculation unit 14 and an instance acquisition unit 15 in addition to the acquisition unit 11, the inventory plan generation unit 12, and the presentation unit 13 included in the inventory plan generation system 1. The storage unit 120 stores various data and programs used by the control unit 110. The communication unit 130 is connected to the network NW to communicate with other devices.

### (Acquisition Unit 11)

The acquisition unit 11 is configured as follows, in addition to acquiring stock information, demand prediction information, money amount information, and constraint information related to a product, similarly to the acquisition unit 11 included in the inventory plan generation system 1. Since the stock information, the demand prediction information, the money amount information, and the constraint information are as described above, detailed description thereof will not be repeated. The acquisition unit 11 may acquire some or all of the demand prediction information by input of user, from the storage device 30, or from the demand prediction device 20. In addition, the acquisition unit 11 may acquire some or all of each of the stock information, the money amount information, the constraint information, and the reference information to be described later by input of user or from the storage device 30. “Acquiring information by input of user” may be, for example, acquiring information input to the head office terminal 40 or the store terminal 50.

Furthermore, the acquisition unit 11 may acquire various types of reference information to be referred to in the inventory plan, in addition to the stock information, the demand prediction information, the money amount information, and the constraint information described above. Examples of the reference information include product information, sales result, measures, external environment, order lead time, and information related to the past order quantity.

Examples of the information related to the product information include a classification code, a product name, an expiration date, a number of order lots, and the like. It can also be said that the money amount information described above is an example of the product information. Examples of the information regarding sales result include sales result by product, by date, by store, and the like. The information related to the sales result is desirably for a predetermined period in the past (e.g., the past one year) or the like. Examples of information related to measures include a measure classification, a period in which measures are taken, a target product of measures, a target store of measures, and a content of measures. The measure may be, for example, a measure for improving sales result of a product, and may be, for example, a measure called a campaign or the like. Examples of the information regarding the external environment include weather information, people flow information, exchange rates, and the like. However, the reference information is not limited to the example described above.

### (Inventory Plan Generation Unit 12)

The inventory plan generation unit 12 is configured as follows in addition to being configured similarly to the inventory plan generation unit 12 included in the inventory plan generation system 1. The inventory plan generation unit 12 generates the inventory plan information in such a way as to reduce, under the constraint information, the value of the objective function including a term weighted based on the suppression balance with respect to the stockout amount and the disposal amount of the product predicted based on the stock information, the demand prediction information, and the money amount information.

Furthermore, the inventory plan generation unit 12 may generate the inventory plan information based on the suppression balance calculated based on the case of the inventory plan information. The calculation of the suppression balance based on the case of the inventory plan information is performed by the calculation unit 14 to be described later. For example, by adopting past good cases as cases of inventory plan information, a user can formulate an actual inventory plan with reference to the inventory plan information based on a suppression balance intended in the past good cases.

In addition, the inventory plan generation unit 12 may change the suppression balance based on the operation of the user and generate the inventory plan information based on the changed suppression balance. As a result, the user can adjust the suppression balance calculated based on the case of the inventory plan information to the suppression balance intended by the user, and can formulate an actual inventory plan with reference to the inventory plan information based on the adjusted suppression balance.

In addition, the inventory plan generation unit 12 may generate a plurality of types of inventory plan information having different suppression balances from each other. The suppression balances different from each other may be designated by a user, selected by a computer, or defined beforehand. This allows the user to formulate an actual inventory plan while comparing how inventory plan information differs due to different suppression balances.

Furthermore, the inventory plan generation unit 12 may generate inventory plan information based on a demand prediction error designated by the user. As a result, the user can formulate an actual inventory plan with reference to the inventory plan information based on the demand prediction error assumed by the user.

In addition, the inventory plan generation unit 12 may generate a plurality of types of inventory plan information having different demand prediction errors from each other. The demand prediction errors different from each other may be designated by a user, selected by a computer, or defined beforehand. This allows the user to formulate an actual inventory plan while comparing how inventory plan information differs due to different demand prediction errors.

For example, in a case where the suppression balance is represented by the weight θ1 and the weight θ2, “θ1×[disposal amount]+θ2×[stockout amount]” is an example of the objective function. The details of the weight θ1 and the weight θ2 are as described above. For example, the disposal amount is calculated based on the prediction value of the near disposal stock quantity and the cost price. The prediction value of the near disposal stock quantity is calculated based on the current stock quantity, the order quantity, the demand prediction quantity, the demand prediction error, the deadline approaching ratio, and the like. The deadline approaching ratio indicates a ratio of the near disposal stock in the inventory. For example, the stockout amount is calculated based on the prediction value of the number of stockouts and the selling price. The prediction value of the number of stockouts is calculated based on the current stock quantity, the order quantity, the demand prediction quantity, the demand prediction error, and the like.

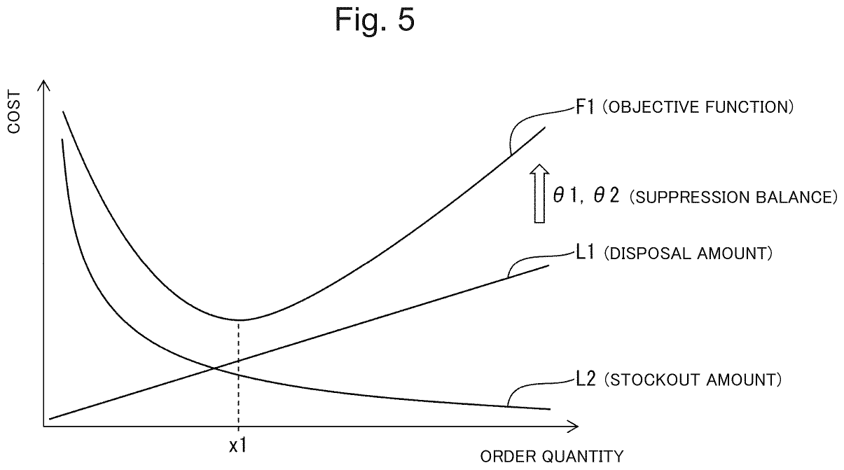

FIG. 5 is a diagram schematically illustrating processing of generating inventory plan information using a suppression balance.

In the graph illustrated in FIG. 5, the vertical axis represents the cost, and the horizontal axis represents the order quantity (an example of information included in the inventory plan information). In addition, L1 represents a disposal amount that changes according to the order quantity, and L2 represents a stockout amount that changes according to the order quantity. The objective function F1 represents “θ1×L1 (disposal amount)+θ2×L2 (stockout amount)”. The order quantity x1 is determined such that the value of the objective function F1 becomes smaller (e.g., at a minimum). Since the shape of the objective function F1 changes when the suppression balances θ1 and θ2 change, the determined order quantity x1 changes according to the strategy of the suppression balance. In a case where the suppression balance calculated from the case of the inventory plan information is adopted as the suppression balances θ1 and θ2, the order quantity x1 is determined based on the strategy of the suppression balance obtained by analyzing the past inventory plan.

An example of the objective function is shown in the following Formula (1).

$$\begin{matrix}[ Mathematical formula 1 ] & \\ {θ}_{1} {\underbrace{{\hat{z}}_{i}^{ne ( t + 1 )} {pp}_{i}^{( t )}}}_{v 1} + {θ}_{2} {\underbrace{( {\hat{y}}_{i}^{( t )} + {e}_{i}^{( t )} - {x}_{i}^{( t )} - {z}_{i}^{ok ( t )} ) {sp}_{i}^{( t )}}}_{v 2} & ( 1 )\end{matrix}$$

In Formula (1), a term v1 related to θ1 indicates a conservative prediction value of the disposal amount. A term v2 related to θ2 indicates a conservative prediction value of the stockout amount. “Conservative” means assuming a worst-case situation of “taking maximum value when difference obtained by subtracting actual number of demands from number of demand prediction values is positive or minimum value when difference is negative”. Details of each term in Formula (1) will be described later.

Furthermore, an example of the constraint information in the objective function of Formula (1) is expressed by the following Formulas (2) to (5).

$$\begin{matrix}[ Mathematical formula 2 ] & \\ {\hat{z}}_{i}^{ne ( t + 1 )} = {α}_{i}^{( t )} {\hat{z}}_{i}^{( t + 1 )} = {α}_{i}^{( t )} \{ {z}_{i}^{ok ( t )} + {x}_{i}^{( t )} - ( {\hat{y}}_{i}^{( t )} - {e}_{i}^{( t )} ) \} & ( 2 )\end{matrix}$$

$$\begin{matrix}[ Mathematical formula 3 ] & \\ ( 1 - {α}_{i}^{( t )} ) {\hat{z}}_{i}^{( t + 1 )} = ( 1 - {α}_{i}^{( t )} ) \{ {z}_{i}^{ok ( t )} + {x}_{i}^{( t )} - ( {\hat{y}}_{i}^{( t )} - {e}_{i}^{( t )} ) \} \leq {sl}_{i}^{( t + 1 )} & ( 3 )\end{matrix}$$

$$\begin{matrix}[ Mathematical formula 4 ] & \\ {z}_{i}^{ok ( t )} + {x}_{i}^{( t )} - ( {\hat{y}}_{i}^{( t )} - {e}_{i}^{( t )} ) \geq 0 & ( 4 )\end{matrix}$$

$$\begin{matrix}[ Mathematical formula 5 ] & \\ {\hat{y}}_{i}^{( t )} + {e}_{i}^{( t )} - {z}_{i}^{ok ( t )} - {x}_{i}^{( t )} \geq 0 & ( 5 )\end{matrix}$$

Formula 2 represents a condition related to a prediction value of the near disposal stock quantity (e.g., an example of disposal quantity). Formula (3) represents a condition related to the upper limit stock quantity. Formula (4) represents a condition in a case of being conservative for the downside. Formula (5) represents a condition in a case of being conservative for the upside. Here, “conservative for the downside” indicates assuming a worst-case situation of “taking maximum value when a difference obtained by subtracting the actual number of demands from the number of demand prediction values is positive”. In addition, “conservative for the upside” indicates assuming a worst-case situation of “taking minimum value when a difference obtained by subtracting the actual number of demands from the number of demand prediction values is negative”. Details of each term in Formulas (2) to (5) will be described later.

Details of each term in Formulas (1) to (5) will be described. Note that, hereinafter, a symbol such as “z with a hat” in Formula (1) or the like is noted as “\hat{ }z” or the like. A symbol “with hat” indicates a prediction value. In addition, the “subscript i” and the like are noted as “_i” and the like.

“i” indicates information for identifying a product to be planned.

In addition, the “superscript (t)” and the like are noted as “\hat{ }(t)” and the like. “t” indicates a timing at which the product i is lined up in the storefront (e.g., date etc.). For example, t=0 indicates a timing serving as a reference (e.g., current).

In the formulas (1) to (5), “x_i\hat{ }(t)”, “\hat{ }z_i\hat{ }ne(t+1)”, and “\hat{ }z_i\hat{ }(t+1)” are decision variables.
“x_\hat{ }(t)” indicates the order quantity at the timing t at which the product i is lined up in the storefront, and is an example of the planned order quantity.
“\hat{ }z_i\hat{ }ne(t+1)” indicates a conservative prediction value for the downside of the near disposal stock quantity immediately before the timing “t+1”. In this example, the near disposal stock quantity is regarded as the disposal quantity.
“\hat{ }z_i\hat{ }(t+1)” indicates a conservative prediction value for the downside of the stock quantity immediately before the timing t+1 at which the product i is lined up in the storefront.

In the formulas (1) to (5), “z_i\hat{ }ok(t)”, “\hat{ }y_i\hat{ }(t)”, “e_i\hat{ }(t)”, “α_i\hat{ }(t)”, “pp_i\hat{ }(t)”, “sp_i\hat{ }(t)”, and “sl_i\hat{ }(t+1)” are constants. The information acquired by the acquisition unit 11 is applied as these constants.
“z_i\hat{ }ok(t)” indicates the stock quantity with a margin until the disposal deadline immediately before the timing t at which the product i is lined up in the storefront.
“\hat{ }y_i\hat{ }(t)” indicates a prediction value (an example of the demand prediction quantity) of the number of sales at the timing t at which the product i is lined up in the storefront.
“e_i\hat{ }(t)” indicates an absolute value (example of demand prediction error) of the prediction error of the number of sales at the timing t at which the product i is lined up in the storefront.
“α_i\hat{ }(t)” indicates a ratio of the near disposal stock quantity of the stock quantity at the timing t at which the product i is lined up in the storefront.
“pp_i\hat{ }(t)” indicates the cost price at the timing t at which the product i is lined up in the storefront.
“sp_i\hat{ }(t)” indicates the selling price at the timing t at which the product i is lined up in the storefront.
“sl_i\hat{ }(t+1)” indicates the upper limit stock quantity at the timing t+1 at which the product i is lined up in the storefront.

For example, the inventory plan generation unit 12 solves a problem of minimizing the objective function shown in Formula (1) under the constraint conditions shown in Formulas (2) to (5). As a result, inventory plan information including “x_\hat{ }(t)” (an example of the planned order quantity), which is one of the decision variables, is generated.

The objective function and the constraint information shown in Formulas (1) to (5) are examples, and these are not the sole case. In addition, for example, in Formulas (1) to (5), the absolute values of the demand prediction errors are the same for both the upside and the downside, but these absolute values may be different. Furthermore, for example, the objective function may further include a term associated with the reference information. Moreover, the constraint information may further include a constraint associated with the reference information.

### (Presentation Unit 13)

The presentation unit 13 is configured as follows in addition to being configured similarly to the presentation unit 13 included in the inventory plan generation system 1. The presentation unit 13 may present a plurality of types of inventory plan information to the user. For example, the plurality of types of inventory plan information may be a plurality of types of inventory plan information having different suppression balances (or demand prediction errors) generated by the inventory plan generation unit 12 from each other. As a result, the user can formulate an actual inventory plan while comparing the plurality of types of inventory plan information.

Furthermore, the presentation unit 13 may present, to the user, a suppression balance calculated by machine learning using a case that satisfies a condition designated by the user among a plurality of cases of inventory plan information related to a product. As a result, the user can know what kind of suppression balance was intended in a case where the condition designated by the user is satisfied, and it can be referred to in formulating an actual inventory plan.

Furthermore, the presentation unit 13 may present, to the user, a plurality of suppression balances calculated by machine learning using each of the cases at least partially different from each other. The plurality of suppression balances mean, for example, that there are a plurality of sets of θ1 and θ2. As a result, it is possible to compare what kind of suppression balance was intended in each of the plurality of cases, and it can be referred to in formulating an actual inventory plan.

When the presentation unit 13 “presents to the user” some kind of information, this means displaying the information on the display device of the head office terminal 40 or the store terminal 50 by transmitting the information to the head office terminal 40 or the store terminal 50.

### (Calculation Unit 14)

The calculation unit 14 calculates the suppression balance by machine learning using a case of inventory plan information related to a product. For example, the case of the inventory plan may be acquired from the storage device 30. For example, the machine learning may be performed by searching for θ1 and θ2 while applying a value based on a case as each term other than θ1 and θ2 indicating the suppression balance in the objective function shown in Formula (1). For such machine learning, a known technique based on reverse reinforcement learning may be adopted.

Furthermore, the calculation unit 14 may calculate the suppression balance by machine learning using a case that satisfies a condition designated by the user among a plurality of cases of inventory plan information related to a product. The condition designated by the user is acquired by the instance acquisition unit 15 described later. As a result, the user can formulate an actual inventory plan with reference to what suppression balance was intended in the case that the user wants to refer to. Examples of the condition that can be designated include, but are not limited to, a condition based on a period, a store, a product genre, or a combination of some or all of them.

Furthermore, the calculation unit 14 may calculate a plurality of suppression balances by machine learning using cases at least partially different from each other as cases of inventory plan information related to a product. Examples of cases at least partially different from each other include, for example, a case related to the store A and a case related to the store B. In addition, examples of other cases at least partially different from each other include, for example, a case related to confectionery, a case related to daily necessities, and the like. However, the cases at least partially different from each other are not limited to the above-described examples. The cases at least partially different from each other may be designated by the user, selected by the computer, or defined beforehand.

### (Instance Acquisition Unit 15)

The instance acquisition unit 15 acquires an instance of inventory plan information for calculating a suppression balance. The instance of the inventory plan information may be acquired from the storage device 30. In addition, the instance of the inventory plan information may be acquired from a management device (not illustrated) that manages stock result and/or order result and the like performed in each store. In addition, an instance satisfying a condition designated by the user may be acquired as an instance of the inventory plan information. In this case, the “designated condition” is input by the user on the head office terminal 40 or the store terminal 50.

### (Flow of Inventory Plan Generation Method S2)

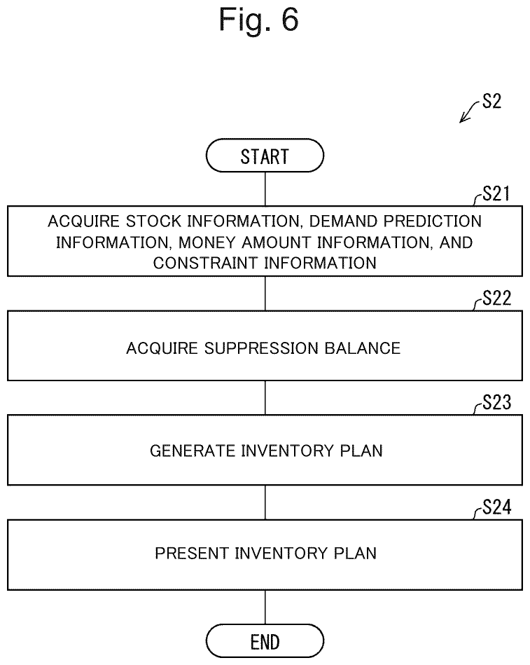

In the inventory plan generation system 1A configured as described above, the inventory plan generation device 10 executes the inventory plan generation method S2. FIG. 6 is a flowchart illustrating a flow of the inventory plan generation method S2. The inventory plan generation method S2 includes steps S21 to S24.

In step S21, the acquisition unit 11 acquires stock information, demand prediction information, money amount information, and constraint information. Furthermore, the acquisition unit 11 may acquire the reference information described above. Some or all of the stock information, the demand prediction information, the money amount information, the constraint information, and the reference information may be acquired from the storage device 30 or may be acquired by input. Furthermore, the demand prediction information may be acquired from the demand prediction device 20.

In step S22, the inventory plan generation unit 12 acquires the suppression balance. The suppression balance may be calculated by a calculation method S3 to be described later, or may be acquired from the storage unit 120. Furthermore, the suppression balance may be acquired by input of a user. In this step, the demand prediction error may be acquired by input of a user.

In step S23, the inventory plan generation unit 12 generates inventory plan information that reduces the value of the objective function under the constraint information. The objective function includes a term in which a weight based on the suppression balance is given to a stockout amount and a disposal amount of a product predicted based on the stock information, the demand prediction information (including the demand prediction error), and the money amount information. Furthermore, the objective function may include reference information.

In step S24, the presentation unit 13 presents the suppression balance and the inventory plan information generated based on the suppression balance. As a result, the user can formulate an actual inventory plan with reference to the inventory plan information in consideration of the suppression balance. Furthermore, the presentation unit 13 may further present a predicted stockout amount and a disposal amount in the inventory plan information.

### Screen Example

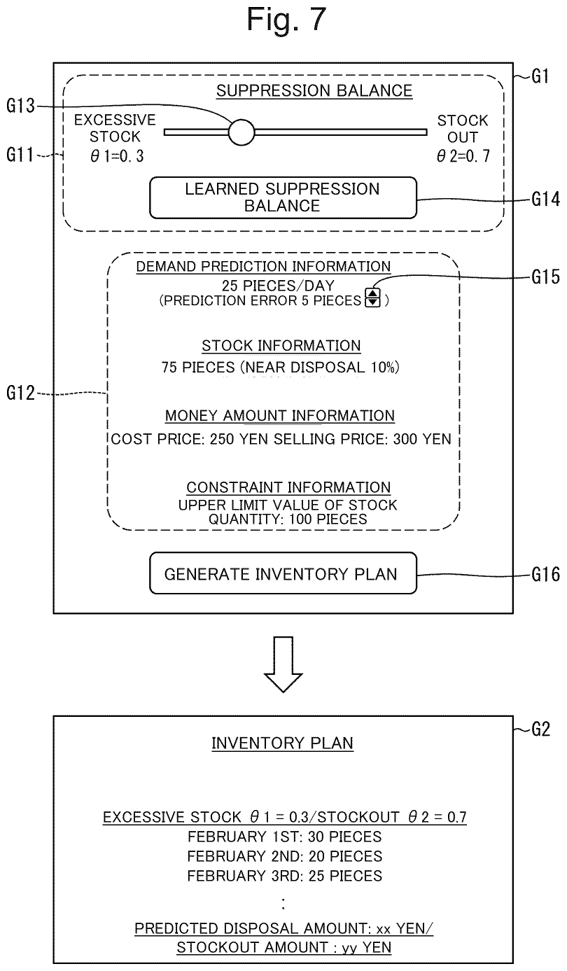

FIG. 7 is a diagram illustrating an example of a screen displayed on the display device of the head office terminal 40 or the store terminal 50 in the inventory plan generation method S2. The screen example G1 illustrated in FIG. 7 is displayed in such a way that the suppression balance and the demand prediction error can be designated by the user in step S22. The screen example G1 includes a region G11 indicating the suppression balance and a region G12 displaying the information acquired by the acquisition unit 11.

The region G11 includes the operation objects G13 and G14. The operation object G13 receives an operation for the user to designate the suppression balance. By the operation of moving the operation object G13 in the left direction in the plane of drawing, the extent θ1 of suppressing the excessive stock becomes relatively small and the extent θ2 of suppressing the stockout becomes relatively large. By the operation of moving the operation object G13 in the right direction in the plane of drawing, the extent θ1 of suppressing the excessive stock becomes relatively large and the extent θ2 of suppressing the stockout becomes relatively small.

Furthermore, when an operation on the operation object G14 “learned suppression balance” is received, a learned suppression balance calculated by machine learning in the calculation method S3 to be described later may be set. In this case, the operation object G13 may move to a position indicating the learned suppression balance according to the operation on the operation object G14. In the initial state of the screen example G1, the learned suppression balance may be set as the initial value.

The region G12 includes the demand prediction information, the stock information, the money amount information, and the constraint information acquired by the acquisition unit 11 in step S21. Furthermore, in a case where the reference information has been acquired, the region G12 may further include the reference information (not illustrated). Moreover, the region G12 includes an operation object G15. The demand prediction error can be changed by an operation on the operation object G15. In the initial state of the screen example G1, the demand prediction error acquired together with the demand prediction quantity from the demand prediction device 20 may be displayed. In the screen example G1, when an operation with respect to the operation object G16 “generate inventory plan” is received, steps S23 to S24 are executed, and the screen example G2 is displayed.

The screen example G2 is displayed in order to present the inventory plan information to the user in step S24. The screen example G2 includes the suppression balance “excessive stock θ1=0.3/stockout θ2=0.7”, the planned stock quantity associated with each date, and the predicted stockout amount (yy yen) and the disposal amount (xx yen). For example, the predicted stockout amount and disposal amount may indicate the sum of the predicted stockout amount and the disposal amount over the entire period included in the inventory plan information. However, the display mode of the predicted stockout amount and disposal amount is not limited thereto. For example, the screen example G2 may include the predicted stockout amount and the disposal amount for each unit period (e.g., date, etc.), or may include an average value of the predicted stockout amount and the disposal amount in each unit period. As a result, the user can formulate an actual inventory plan with reference to the inventory plan information generated in consideration of the suppression balance and the predicted stockout amount and disposal amount.

In the screen example G1, the user does not necessarily need to designate the suppression balance or the demand prediction error. In this case, the suppression balance and the demand prediction error displayed in the initial state of the screen example G1 are applied. Furthermore, the screen displayed in the inventory plan generation method S2 is not limited to the screen examples G1 and G2. Moreover, for example, display of the screen example G1 is not essential. For example, a preset suppression balance may be applied. In addition, for example, a demand prediction error calculated by the demand prediction device 20 may be applied. As a result, the user can refer to the inventory plan information generated based on the suppression balance set beforehand.

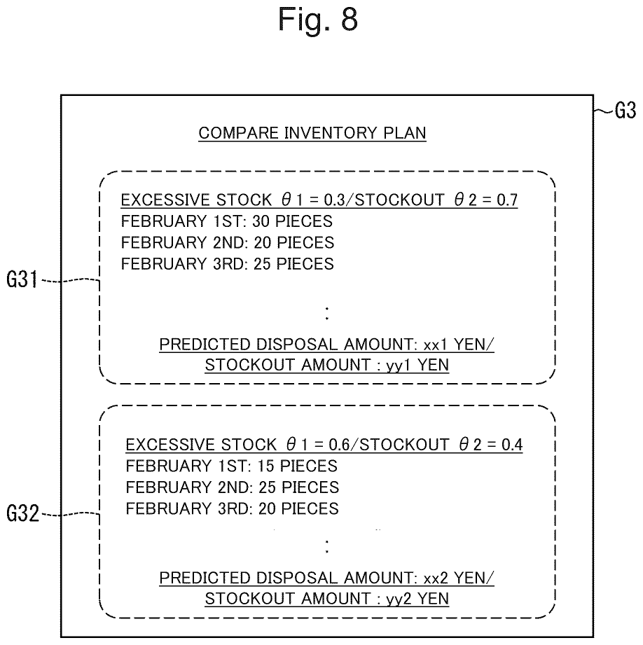

For example, in a case where a plurality of suppression balances (or a plurality of demand prediction errors) are acquired in step S22, inventory plan information corresponding to each of the suppression balances is generated in step S23. In this case, for example, a screen for comparing the plurality of pieces of inventory plan information may be displayed in step S24. FIG. 8 is a diagram illustrating an example of a screen including a plurality of pieces of inventory plan information. The screen example G3 illustrated in FIG. 8 includes regions G31 and G32. The region G31 includes inventory plan information generated based on the suppression balance “excessive stock θ1=0.3/stockout θ2=0.7”, and the predicted stockout amount and disposal amount. The region G32 includes inventory plan information generated based on the suppression balance “excessive stock θ1=0.6/stockout θ2=0.4”, and the predicted stockout amount and disposal amount.

As a result, the user can formulate an actual inventory plan with reference to a difference in the inventory plan information due to a difference in the suppression balance and a difference in the predicted stockout amount and disposal amount.

### (Flow of Calculation Method S3)

In addition, the inventory plan generation device 10 executes a calculation method S3 for calculating the suppression balance. The calculation method S3 may be executed in step S22 of the inventory plan generation method S2, or may be executed asynchronously with the inventory plan generation method S2. In the case of being executed asynchronously, for example, the calculation method S3 may be executed periodically (e.g., monthly, quarterly, etc.). In this case, it is desirable that the case of the inventory plan information to be referenced is updated periodically. Furthermore, in the case of being executed asynchronously, for example, the calculation method S3 may be executed based on an instruction of the user.

In addition, the suppression balance calculated by the calculation method S3 may be used in the inventory plan generation method S2, or the suppression balance designated by the user with reference to the suppression balance may be used in the inventory plan generation method S2.

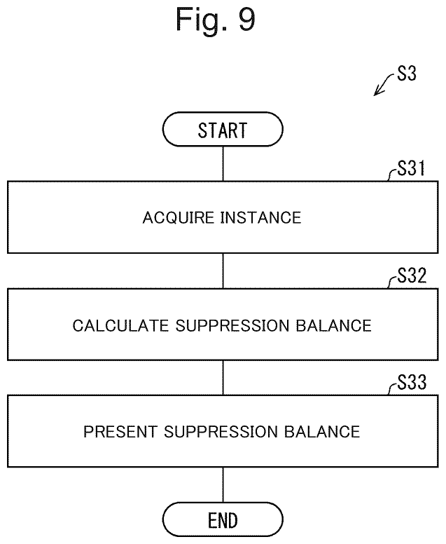

FIG. 9 is a flowchart illustrating a flow of the calculation method S3. The calculation method S3 includes steps S31 to S33.

In step S31, the instance acquisition unit 15 acquires an instance of inventory plan information to be referred to for calculating the suppression balance. The instance may be acquired from the storage device 30, may be acquired from the management device, or may be acquired based on a condition designated by the user.

In step S32, the calculation unit 14 calculates the suppression balance by machine learning using the acquired instance. For example, one suppression balance may be calculated, or a plurality of suppression balances may be calculated.

In step S33, the presentation unit 13 presents the calculated one or a plurality of suppression balances. As a result, the user can know what kind of suppression balance was intended in the historical instance of the inventory plan information. Furthermore, in a case where a plurality of suppression balances are presented, it is possible to compare what kind of suppression balance was intended in each of a plurality of instances. Furthermore, the user can designate the suppression balance to be used in the inventory plan generation method S2 described above with reference to the presented suppression balance. In addition, the predicted stockout amount and the disposal amount may be further presented by the inventory plan generation method S2 using the suppression balance. As a result, the user can confirm the predicted stockout amount and disposal amount in a case where the calculated suppression balance is adopted. In addition, in a case where a plurality of suppression balances are presented, the predicted stockout amount and the disposal amount predicted may be further presented by the inventory plan generation method S2 using each of the plurality of suppression balances. As a result, the user can confirm a difference between the predicted stockout amount and the disposal amount in a case where each of the plurality of suppression balances is adopted.

### Screen Example

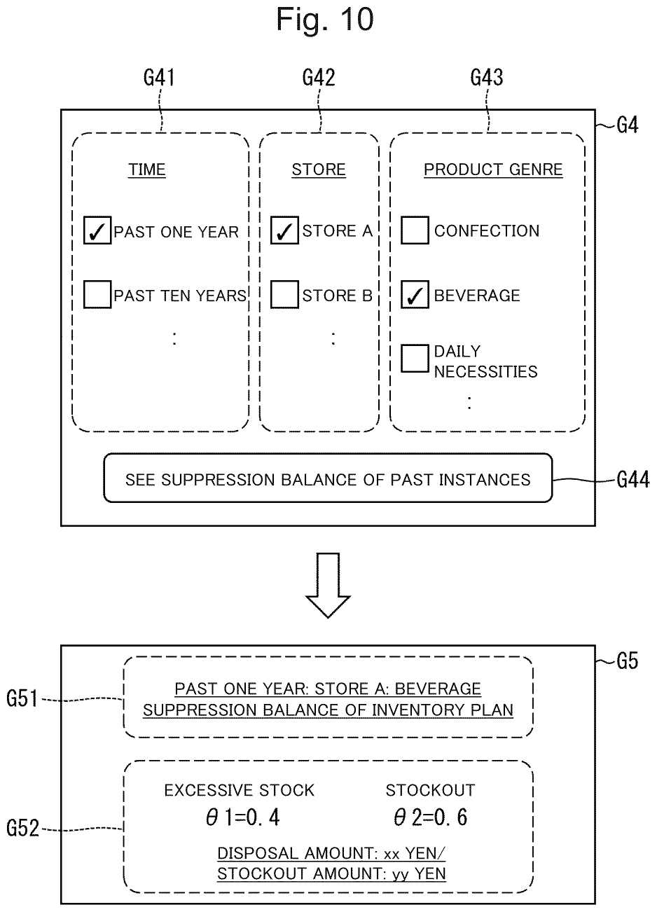

FIG. 10 is a diagram illustrating an example of a screen displayed on the display device of the head office terminal 40 or the store terminal 50 in the calculation method S3. The screen example G4 illustrated in FIG. 10 is displayed in order for the user to designate the condition of the instance to be acquired in step S31. The screen example G4 includes a region G41 for designating a time, a region G42 for designating a store, and a region G43 for designating a product genre. In other words, it is possible to designate a condition related to a time, a store, and a product genre as a condition of an instance to be acquired. In the screen example G4, “past one year” is designated as the time, “store A” is designated as the store, and “beverage” is designated as the product genre. In the screen example G4, when the operation with respect to the operation object G44 “view the suppression balance of the historical instance” is received, steps S31 to S33 are executed and the screen example G5 is displayed.

The screen example G5 is displayed in order to present the suppression balance to the user in step S33. The screen example G5 includes a region G51 indicating the condition designated by the user and a region G52 indicating the calculated suppression balance. In addition, “disposal amount: xx yen/stockout amount: yy yen” included in the region G52 indicates results of the stockout amount and the disposal amount in a case where the designated condition is satisfied. The results of the stockout amount and the disposal amount may indicate the sum of the results of the stockout amount and the disposal amount over the entire period included in the instance. However, the display mode of the results of the stockout amount and the disposal amount is not limited thereto. For example, the region G52 may include the results of the stockout amount and the disposal amount for each unit period (e.g., date, etc.) in the instance, or may include an average value of the results of the stockout amount and the disposal amount in each unit period. Thus, the user can know what kind of suppression balance was intended in an instance where the condition designated by the user is satisfied, and what the stockout amount and disposal amount was as a result.

The calculation processing of the suppression balance (step S32) is not limited to being executed in response to the operation with respect to the operation object G44 of the screen example G4, and may be executed beforehand.

For example, the suppression balance calculated based on an instance satisfying a typical condition may be calculated in advance and stored in the storage unit 120. In this case, the calculation processing of the suppression balance may be executed in response to the operation with respect to the operation object G44 only in a case where the suppression balance corresponding to the condition designated by the user is not stored in the storage unit 120.

In addition, the screen displayed in the calculation method S3 is not limited to the screen examples G4 and G5. For example, the designation of the condition in the screen example G4 may be input in a natural language sentence. In addition, the screen example G5 may include a plurality of suppression balances corresponding to instances at least partially different from each other. As a result, the user can compare the plurality of suppression balances.

Furthermore, for example, the display of the screen example G4 (in other words, designation of a condition by the user) is not essential. For example, the suppression balance calculated based on an instance acquired based on a condition set in advance may be displayed in the screen example G5. As a result, the user can know the suppression balance intended in the preset (e.g., typical) instance even if the user does not designate the condition.

Furthermore, the display of the screen example G5 (in other words, execution of step S33) is not essential. The suppression balance calculated in step S32 may be stored in, for example, the storage unit 120 and referred to in the inventory plan generation method S2. For example, the suppression balance referred to in the inventory plan generation method S2 may be updated by the execution of the calculation method S3.

### Application Example

For example, in the inventory plan generation system 1A, the user of the head office terminal 40 may update the suppression balance used by the inventory plan generation device 10 by designating, as an instance, inventory plan information indicating an excellent inventory plan among past inventory plans actually performed by a plurality of stores. Furthermore, for example, the user of the store terminal 50 may formulate an actual inventory plan with reference to inventory plan information generated using the learned suppression balance. Moreover, for example, the user of the store terminal 50 can also perform trial and error by causing the inventory plan generation system 1A to generate various inventory plan information while correcting the suppression balance based on the learned suppression balance. Furthermore, for example, the user of the store terminal 50 can know what kind of suppression balance is intended in the excellent inventory plan by designating another store that performs the excellent inventory plan as a condition. Furthermore, for example, the user of the store terminal 50 can input the reference information (e.g., a store specific campaign, etc.) unique to the store, and can perform the inventory plan suitable for the situation of the own store while appropriately incorporating the suppression balance in the instance of the excellent inventory plan by another store.

### (Effect of Inventory Plan Generation System)

As described above, in the inventory plan generation system 1A, a configuration is adopted in which the acquisition unit 11 further acquires the money amount information and the constraint information regarding the product, and the inventory plan generation unit 12 generates the inventory plan information in such a way as to reduce the value of the objective function including the term weighted based on the suppression balance with respect to the stockout amount and the disposal amount of the product predicted based on the stock information, the demand prediction information, and the money amount information, under the constraint information. For this reason, according to the inventory plan generation system 1A, in addition to the effect obtained by the inventory plan generation system 1, an effect is obtained that the formulation of the inventory plan in consideration of the balance of suppressing each of the stockout amount and the disposal amount can be supported.

In addition, the inventory plan generation system 1A adopts a configuration of further including a calculation means for calculating a suppression balance by machine learning using an instance of inventory plan information related to a product. Therefore, according to the inventory plan generation system 1A, in addition to the effect obtained by the inventory plan generation system 1, an effect is obtained that the formulation of the inventory plan in consideration of the suppression balance intended in the instance can be supported.

Furthermore, in the inventory plan generation system 1A, a configuration is adopted in which the calculation unit 14 calculates a suppression balance by machine learning using an instance that satisfies a condition designated by the user among a plurality of instances of inventory plan information related to a product, and the presentation unit 13 presents the suppression balance to the user. Therefore, according to the inventory plan generation system 1A, in addition to the effect obtained by the inventory plan generation system 1, an effect is obtained that the user can know the suppression balance intended in the instance that satisfies the condition designated by the user.

Furthermore, in the inventory plan generation system 1A, a configuration is adopted in which the calculation unit 14 calculates a plurality of suppression balances by machine learning using instances at least partially different from each other as instances of inventory plan information related to a product, and the presentation unit 13 presents the plurality of suppression balances to the user. Therefore, according to the inventory plan generation system 1A, in addition to the effect obtained by the inventory plan generation system 1, an effect is obtained that the user can compare and refer to the suppression balance intended in the instances at least partially different from each other.

Furthermore, in the inventory plan generation system 1A, a configuration is adopted in which the inventory plan generation unit 12 changes the suppression balance based on the operation of the user and generates the inventory plan information based on the changed suppression balance. Therefore, according to the inventory plan generation system 1A, in addition to the effect obtained by the inventory plan generation system 1, an effect is obtained that the user can adjust the suppression balance calculated based on the historical instance of the inventory plan information to the suppression balance intended by the user, and can formulate the actual inventory plan with reference to the inventory plan information generated based on the adjusted suppression balance. Furthermore, in a case where the prediction results of the stockout amount and the disposal amount are presented together with the inventory plan information, an effect is obtained that the user can formulate an actual inventory plan in consideration of the prediction results of the stockout amount and the disposal amount by the adjusted suppression balance.

Furthermore, in the inventory plan generation system 1A, a configuration is adopted in which the inventory plan generation unit 12 generates a plurality of types of inventory plan information having different suppression balances from each other, and the presentation unit 13 presents the plurality of types of inventory plan information to the user. Therefore, according to the inventory plan generation system 1A, in addition to the effect obtained by the inventory plan generation system 1, an effect is obtained that the user can formulate an actual inventory plan while comparing a plurality of types of inventory plan information having different suppression balances from each other. Furthermore, in a case where the prediction results of the stockout amount and the disposal amount are presented together with a plurality of types of inventory plan information, an effect is obtained that the user can formulate an actual inventory plan while comparing the prediction results of the stockout amount and the disposal amount by the suppression balances different from each other.

Furthermore, in the inventory plan generation system 1A, a configuration is adopted in which the inventory plan generation unit 12 generates inventory plan information based on a demand prediction error designated by the user. Therefore, according to the inventory plan generation system 1A, in addition to the effect obtained by the inventory plan generation system 1, an effect is obtained that the user can formulate an actual inventory plan while referring to the inventory plan information generated based on the demand prediction error designated by the user.

Furthermore, in the inventory plan generation system 1A, a configuration is adopted in which the inventory plan generation unit 12 generates a plurality of types of inventory plan information having different demand prediction errors from each other, and the presentation unit 13 presents the plurality of types of inventory plan information to the user. Therefore, according to the inventory plan generation system 1A, in addition to the effect obtained by the inventory plan generation system 1, an effect is obtained that the user can formulate an actual inventory plan while comparing a plurality of types of inventory plan information having different demand prediction errors from each other.

### Example of Implementation by Software

Some or all of the functions of each device (hereinafter, also referred to as “each of the above devices”) constituting the inventory plan generation system 1 and the inventory plan generation system 1A may be achieved by hardware such as an integrated circuit (IC chip) or may be achieved by software.

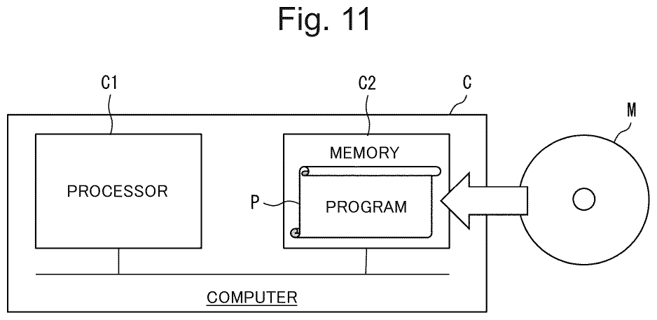

In the latter case, each of the above devices is implemented by, for example, a computer that executes commands of a program, that is software for implementing each function. An example of such a computer (hereinafter referred to as a computer C) is illustrated in FIG. 11. FIG. 11 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof or the like can be used. As the memory C2, for example, a flash memory, a Hard Disk Drive (HDD), a Solid State Drive (SSD), or a combination thereof, or the like can be used.

The computer C may further include a Random Access Memory (RAM) for loading the program P at the time of execution and temporarily storing various sorts of data. The computer C may further include a communication interface for sending and receiving data to and from another device. The computer C may further include an input/output interface for connecting input/output device such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by a single processor provided in a single computer, may be implemented in cooperation by a plurality of processors provided in a single computer, or may be implemented in cooperation by a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information A

The present disclosure includes the techniques described in the following supplementary notes. However, the present disclosure is not limited to the techniques described in the following supplementary notes, and various modifications can be made within the scope described in the claims.

### Supplementary Note A1

An inventory plan generation system including,
an acquisition means for acquiring stock information, demand prediction information, money amount information, and constraint information related to a product,
an inventory plan generation means for generating inventory plan information related to the product in such a way as to suppress a predicted stockout and an excessive stock based on the stock information, the demand prediction information, the money amount information, and the constraint information, based on a suppression balance of a stockout and an excessive stock of the product, the suppression balance being calculated based on an instance of inventory plan information related to the product, and
a presentation means for presenting the suppression balance and the inventory plan information to a user.

### Supplementary Note A2

The inventory plan generation system according to supplementary note A1, in which
the acquisition means further acquires money amount information and constraint information related to the product, and
the inventory plan generation means generates the inventory plan information to reduce, based on the constraint information, a value of an objective function including a term weighted based on the suppression balance with respect to a stockout amount and a disposal amount of the product predicted based on the stock information, the demand prediction information, and the money amount information.

### Supplementary Note A3

The inventory plan generation system according to supplementary note A1 or A2, further including a calculation means for calculating the suppression balance by machine learning using an instance of inventory plan information related to the product.

### Supplementary Note A4

The inventory plan generation system according to supplementary note A3, in which
the calculation means calculates the suppression balance by machine learning using an instance that satisfies a condition designated by the user among a plurality of instances of inventory plan information related to the product, and
the presentation means presents the suppression balance to the user.

### Supplementary Note A5

The inventory plan generation system according to supplementary note A3 or A4, in which
the calculation means calculates a plurality of the suppression balance by machine learning using each of instances at least partially different from each other as an instance of inventory plan information related to the product, and
the presentation means presents the plurality of suppression balances to the user.

### Supplementary Note A6

The inventory plan generation system according to any one of supplementary notes A1 to A5, in which the inventory plan generation means changes the suppression balance based on an operation of the user, and generates the inventory plan information based on the changed suppression balance.

### Supplementary Note A7

The inventory plan generation system according to any one of supplementary notes A1 to A6, in which
the inventory plan generation means generates a plurality of types of the inventory plan information having different suppression balances from each other, and
the presentation means presents a plurality of types of the inventory plan information to the user.

### Supplementary Note A8

The inventory plan generation system according to any one of supplementary notes A1 to A7, in which the inventory plan generation means generates the inventory plan information based on a demand prediction error designated by the user.

### Supplementary Note A9

The inventory plan generation system according to any one of supplementary notes A1 to A8, in which
the inventory plan generation means generates a plurality of types of the inventory plan information having different demand prediction errors from each other, and
the presentation means presents the plurality of types of the inventory plan information to the user.

### Supplementary Information B

The present disclosure includes the techniques described in the following supplementary notes. However, the present disclosure is not limited to the techniques described in the following supplementary notes, and various modifications can be made within the scope described in the claims.

### Supplementary Note B1

An inventory plan generation method including,
acquisition processing in which at least one processor acquires stock information, demand prediction information, money amount information, and constraint information related to a product,
inventory plan generation processing in which the at least one processor generates inventory plan information related to the product in such a way as to suppress a predicted stockout and an excessive stock based on the stock information, the demand prediction information, the money amount information, and the constraint information, based on a suppression balance of a stockout and an excessive stock of the product, the suppression balance being calculated based on an instance of inventory plan information related to the product, and
presentation processing in which the at least one processor presents the suppression balance and the inventory plan information to a user.

### Supplementary Note B2

The inventory plan generation method according to supplementary note B1, in which
in the acquisition processing, the at least one processor further acquires money amount information and constraint information related to the product, and
in the inventory plan generation processing, the at least one processor generates the inventory plan information in such a way as to reduce, under the constraint information, a value of an objective function including a term weighted based on the suppression balance with respect to a stockout amount and a disposal amount of the product predicted based on the stock information, the demand prediction information, and the money amount information.

### Supplementary Note B3

The inventory plan generation method according to supplementary note B1 or B2, further including calculation processing in which the at least one processor calculates the suppression balance by machine learning using an instance of inventory plan information related to the product.

### Supplementary Note B4

The inventory plan generation method according to supplementary note B3, in which
in the calculation processing, the at least one processor calculates the suppression balance by machine learning using an instance that satisfies a condition designated by the user among a plurality of instances of inventory plan information related to the product, and
in the presentation processing, the at least one processor presents the suppression balance to the user.

### Supplementary Note B5

The inventory plan generation method according to supplementary note B3 or B4, in which
in the calculation processing, the at least one processor calculates a plurality of the suppression balance by machine learning using each of instances at least partially different from each other as an instance of inventory plan information related to the product, and
in the presentation processing, the at least one processor presents the plurality of the suppression balances to the user.

### Supplementary Note B6

The inventory plan generation method according to any one of supplementary notes B1 to B5, in which in the inventory plan generation processing, the at least one processor changes the suppression balance based on an operation of the user, and generates the inventory plan information based on the changed suppression balance.

### Supplementary Note B7

The inventory plan generation method according to any one of supplementary notes B1 to B6, in which
in the inventory plan generation processing, the at least one processor generates a plurality of types of the inventory plan information having different suppression balances from each other, and
in the presentation processing, the at least one processor presents a plurality of types of the inventory plan information to the user.

### Supplementary Note B8

The inventory plan generation method according to any one of supplementary notes B1 to B7, in which in the inventory plan generation processing, the at least one processor generates the inventory plan information based on a demand prediction error designated by the user.

### Supplementary Note B9

The inventory plan generation method according to any one of supplementary notes B1 to B8, in which
in the inventory plan generation processing, the at least one processor generates a plurality of types of the inventory plan information having different demand prediction errors from each other, and
in the presentation processing, the at least one processor presents the plurality of types of the inventory plan information to the user.

### Supplementary Information C

The present disclosure includes the techniques described in the following supplementary notes. However, the present disclosure is not limited to the techniques described in the following supplementary notes, and various modifications can be made within the scope described in the claims.

### Supplementary Note C1

An inventory plan generation program for causing a computer to function as an inventory plan generation system, the program causing the computer to function as,
an acquisition means for acquiring stock information, demand prediction information, money amount information, and constraint information related to a product,
an inventory plan generation means for generating inventory plan information related to the product in such a way as to suppress a predicted stockout and an excessive stock based on the stock information, the demand prediction information, the money amount information, and the constraint information, based on a suppression balance of a stockout and an excessive stock of the product, the suppression balance being calculated based on an instance of inventory plan information related to the product, and
a presentation means for presenting the suppression balance and the inventory plan information to a user.

### Supplementary Note C2

The inventory plan generation program according to supplementary note C1, in which
the acquisition means further acquires money amount information and constraint information related to the product, and
the inventory plan generation means generates the inventory plan information to reduce, based on the constraint information, a value of an objective function including a term weighted based on the suppression balance with respect to a stockout amount and a disposal amount of the product predicted based on the stock information, the demand prediction information, and the money amount information.

### Supplementary Note C3

The inventory plan generation program according to supplementary note C1 or C2, further causing the computer to function as a calculation means for calculating the suppression balance by machine learning using an instance of inventory plan information related to the product.

### Supplementary Note C4

The inventory plan generation program according to supplementary note C3, in which
the calculation means calculates the suppression balance by machine learning using an instance that satisfies a condition designated by the user among a plurality of instances of inventory plan information related to the product, and
the presentation means presents the suppression balance to the user.

### Supplementary Note C5

The inventory plan generation program according to supplementary note C3 or C4, in which
the calculation means calculates a plurality of the suppression balance by machine learning using each of instances at least partially different from each other as an instance of inventory plan information related to the product, and
the presentation means presents the plurality of suppression balances to the user.

### Supplementary Note C6

The inventory plan generation program according to any one of supplementary notes C1 to C5, in which the inventory plan generation means changes the suppression balance based on an operation of the user, and generates the inventory plan information based on the changed suppression balance.

### Supplementary Note C7

The inventory plan generation program according to any one of supplementary notes C1 to C6, in which
the inventory plan generation means generates a plurality of types of the inventory plan information having different suppression balances from each other, and
the presentation means presents a plurality of types of the inventory plan information to the user.

### Supplementary Note C8

The inventory plan generation program according to any one of supplementary notes C1 to C7, in which the inventory plan generation means generates the inventory plan information based on a demand prediction error designated by the user.

### Supplementary Note C9

The inventory plan generation program according to any one of supplementary notes C1 to C8, in which
the inventory plan generation means generates a plurality of types of the inventory plan information having different demand prediction errors from each other, and
the presentation means presents a plurality of types of the inventory plan information to the user.

### Supplementary Information D

The present disclosure includes the techniques described in the following supplementary notes. However, the present disclosure is not limited to the techniques described in the following supplementary notes, and various modifications can be made within the scope described in the claims.

### Supplementary Note D1

An inventory plan generation system including at least one processor, in which the at least one processor executes,
acquisition processing of acquiring stock information, demand prediction information, money amount information, and constraint information related to a product,
inventory plan generation processing of generating inventory plan information related to the product in such a way as to suppress a predicted stockout and an excessive stock based on the stock information, the demand prediction information, the money amount information, and the constraint information, based on a suppression balance of a stockout and an excessive stock of the product, the suppression balance being calculated based on an instance of inventory plan information related to the product, and
presentation processing of presenting the suppression balance and the inventory plan information to a user.

The inventory plan generation system may further include a memory. The memory may store a program for causing the at least one processor to execute each of the processing.

### Supplementary Note D2

The inventory plan generation system according to supplementary note D1, in which
in the acquisition processing, the at least one processor further acquires money amount information and constraint information related to the product, and
in the inventory plan generation processing, the at least one processor generates the inventory plan information in such a way as to reduce, under the constraint information, a value of an objective function including a term weighted based on the suppression balance with respect to a stockout amount and a disposal amount of the product predicted based on the stock information, the demand prediction information, and the money amount information.

### Supplementary Note D3

The inventory plan generation system according to supplementary note D1 or D2, in which the at least one processor further executes calculation processing of calculating the suppression balance by machine learning using an instance of inventory plan information related to the product.

### Supplementary Note D4

The inventory plan generation system according to supplementary note D3, in which
in the calculation processing, the at least one processor calculates the suppression balance by machine learning using an instance that satisfies a condition designated by the user among a plurality of instances of inventory plan information related to the product, and
in the presentation processing, the at least one processor presents the suppression balance to the user.

### Supplementary Note D5

The inventory plan generation system according to supplementary note D3 or D4, in which
in the calculation processing, the at least one processor calculates a plurality of the suppression balance by machine learning using each of instances at least partially different from each other as an instance of inventory plan information related to the product, and
in the presentation processing, the at least one processor presents the plurality of the suppression balances to the user.

### Supplementary Note D6

The inventory plan generation system according to any one of supplementary notes D1 to D5, in which in the inventory plan generation processing, the at least one processor changes the suppression balance based on an operation of the user, and generates the inventory plan information based on the changed suppression balance.

### Supplementary Note D7

The inventory plan generation system according to any one of supplementary notes D1 to D6, in which
in the inventory plan generation processing, the at least one processor generates a plurality of types of the inventory plan information having different suppression balances from each other, and
in the presentation processing, the at least one processor presents the plurality of types of the inventory plan information to the user.

### Supplementary Note D8

The inventory plan generation system according to any one of supplementary notes D1 to D7, in which in the inventory plan generation processing, the at least one processor generates the inventory plan information based on a demand prediction error designated by the user.

### Supplementary Note D9

The inventory plan generation system according to any one of supplementary notes D1 to D8, in which
in the inventory plan generation processing, the at least one processor generates a plurality of types of the inventory plan information having different demand prediction errors from each other, and
in the presentation processing, the at least one processor presents the plurality of types of the inventory plan information to the user.

### Supplementary Information E

The present disclosure includes the techniques described in the following supplementary notes. However, the present disclosure is not limited to the techniques described in the following supplementary notes, and various modifications can be made within the scope described in the claims.

### Supplementary Note E1

A non-transitory recording medium recorded with an inventory plan generation program for causing a computer to function as an inventory plan generation system, the inventory plan generation program causing the computer to execute,
acquisition processing of acquiring stock information, demand prediction information, money amount information, and constraint information related to a product,
inventory plan generation processing of generating inventory plan information related to the product in such a way as to suppress a predicted stockout and an excessive stock based on the stock information, the demand prediction information, the money amount information, and the constraint information, based on a suppression balance of a stockout and an excessive stock of the product, the suppression balance being calculated based on an instance of inventory plan information related to the product, and
presentation processing of presenting the suppression balance and the inventory plan information to a user.

1. An inventory plan generation system comprising:
at least one memory storing instructions; and
at least one processor configured to execute the instructions to:
acquire stock information, demand prediction information, money amount information, and constraint information related to a product;
predict a stockout and an excessive stock of the product by using the stock information, the demand prediction information, the money amount information, and the constraint information;
acquire a suppression balance between stockout and excessive stock of the product, the suppression balance being calculated based on an instance of inventory plan information related to the product;
generate inventory plan information related to the product in such a way as to suppress the stockout and the excessive stock predicted, based on the suppression balance; and
present the suppression balance and the inventory plan information to a user.

2. The inventory plan generation system according to claim 1, wherein the at least one processor is further configured to execute the instructions to:
predict a stockout amount and a disposal amount of the product by using the stock information, the demand prediction information, and the money amount information; and
generate the inventory plan information to reduce, under constraints indicated by the constraint information, a value of an objective function including a term weighted based on the suppression balance with respect to the stockout amount and the disposal amount of the product predicted.

3. The inventory plan generation system according to claim 1, wherein the at least one processor is further configured to execute the instructions to:
calculate the suppression balance by machine learning using an instance of inventory plan information related to the product.

4. The inventory plan generation system according to claim 3, wherein the at least one processor is further configured to execute the instructions to:
calculate the suppression balance by machine learning using an instance that satisfies a condition designated by the user among a plurality of instances of inventory plan information related to the product; and
present the suppression balance to the user.

5. The inventory plan generation system according to claim 3, wherein the at least one processor is further configured to execute the instructions to:
calculate a plurality of the suppression balance by machine learning using each of instances at least partially different from each other as an instance of inventory plan information related to the product; and
present the plurality of the suppression balance to the user.

6. The inventory plan generation system according to claim 1, wherein the at least one processor is further configured to execute the instructions to:
change the suppression balance based on an operation of the user; and
generate the inventory plan information based on the changed suppression balance.

7. The inventory plan generation system according to claim 1, wherein the at least one processor is further configured to execute the instructions to:
generate a plurality of types of the inventory plan information, each having different suppression balances; and
present the plurality of types of the inventory plan information to the user.

8. The inventory plan generation system according to claim 1, wherein the at least one processor is further configured to execute the instructions to:
generate the inventory plan information based on a demand prediction error designated by the user.

9. An inventory plan generation method comprising:
acquiring stock information, demand prediction information, money amount information, and constraint information related to a product;
predicting a stockout and an excessive stock by using the stock information, the demand prediction information, the money amount information, and the constraint information;
acquiring a suppression balance between stockout and excessive stock of the product, the suppression balance being calculated based on an instance of inventory plan information related to the product;
generating inventory plan information related to the product in such a way as to suppress the stockout and the excessive stock predicted, based on the suppression balance; and
presenting the suppression balance and the inventory plan information to a user.

10. A non-transitory computer-readable recording medium storing an inventory plan generation program causing a computer to execute processing comprising:
acquiring stock information, demand prediction information, money amount information, and constraint information related to a product;
predicting a stockout and an excessive stock by using the stock information, the demand prediction information, the money amount information, and the constraint information;
acquiring a suppression balance between stockout and excessive stock of the product, the suppression balance being calculated based on an instance of inventory plan information related to the product;
generating inventory plan information related to the product in such a way as to suppress the stockout and the excessive stock predicted, based on the suppression balance; and
presenting the suppression balance and the inventory plan information to a user.

11. The inventory plan generation system according to claim 1, wherein the suppression balance indicates to what extent each of the stockout and the excessive stock having a trade-off relationship is to be suppressed.

12. The inventory plan generation system according to claim 1, wherein the at least one processor is further configured to execute the instructions to:
receive an operation of the user for changing the suppression balance; and
generate additional inventory plan information based on the changed suppression balance, thereby supporting the user's decision-making.
